(19) United States
(12) Patent Application Publication
(10) Pub. No.: US 2011/0099077 A1
(43) Pub. Date: Apr. 28, 2011

(54) SYSTEM AND METHOD FOR PROVIDING STORAGE, RETREIVAL, CUSTOMIZATION, ADAPTION, DISTRIBUTION AND MANAGEMENT OF ELECTRONIC ADVERTISEMENTS

(76) Inventors: Shai Darin, Tel-Aviv (IL); Micha Berkuz, Tel-Aviv (IL); Yanir Shahak, Tel-Aviv (IL)

(21) Appl. No.: 12/796,176

(22) Filed: Jun. 8, 2010

Related U.S. Application Data
(60) Provisional application No. 61/185,055, filed on Jun. 8, 2009.

(51) Int. Cl. G06Q 30/00

(52) U.S. Cl. 705/14.72; 705/14.73

(57) ABSTRACT

Method for providing an electronic advertisement to a client system via a server system, the server system coupled with an electronic advertisement database for storing a plurality of electronic advertisement data structures that each defines a respective electronic advertisement, each electronic advertisement data structure attributes at least one advertising field designation to each respective electronic advertisement, the client system hosting a client website employing a characteristic design scheme, the method comprising the procedures of establishing communications between the server system and the client system, registering the client system the server system, providing a retrieval and adaptation object from the server system to the client system, integrating the retrieval and adaptation object into the client website, retrieving by the retrieval and adaptation object the electronic advertisement data pertaining to the respective electronic advertisement from the electronic advertisement database according to at least one advertising field designation, and incorporating the electronic advertisement into the client webpage by substantially adapting the retrieved electronic advertising data of the respective the electronic advertisement, to substantially correspond with the characteristic design scheme.

### RELATED APPLICATIONS

This application claims priority to U.S. Patent Application No. 61/185,055, entitled “System and Method for Providing Storage, Retrieval, Customization, Adaptation, Distribution and Management of Electronic Advertisements,” filed on Jun. 8, 2009. This application is incorporated herein in its entirety by this reference.

### FIELD OF THE DISCLOSED TECHNIQUE

The disclosed technique relates to the use of electronic advertisements, in general, and to a system and method for providing an electronic advertising platform for enabling storage, retrieval, customization, adaptation, distribution, and management, of electronic advertisements, in particular.

### BACKGROUND OF THE DISCLOSED TECHNIQUE

In the fields of advertising, marketing, and commerce, advertisements can include electronic coupon advertisements, banner advertisements, text advertisements, and the like. Banner advertisements are typically constructed from multimedia objects (e.g., images, animations, video), which are embedded into web pages. Text advertisements are also embedded into web pages, although they usually employ text-based hyperlinks. A coupon may refer to a form (such as a certificate, a ticket, a statement of due interest, a voucher) yielded for the purposes of obtaining an article, service, opportunity, or accommodation. For example, a coupon may be a ticket or voucher that can be exchanged for a discount or rebate when purchasing merchandise or services. A coupon may also refer to certificate or receipt (e.g., a proof of purchase of a particular product) that may be redeemable in premiums for purchasing other products. Coupons are typically issued by manufacturers, retailers (i.e., or third parties), and can be embodied into a printed form (i.e., printed coupons). These coupons may then be distributed, for example, through publications (e.g., newspapers, magazines, books), mail, third-party vendors, and by consumer products. Electronic coupons, such as Internet coupons, which are displayed on the web pages of websites, may be distributed through the Internet (e.g., via e-mail) and do not incur the traditional postal costs for their distribution.

Another Internet advertising scheme involves the use of the Pay-Per-Click (PPC) model employed for example, in advertising networks, content websites (e.g., blogs), and in search engines. According to this model, advertisers pay their host website only when their advertisement is clicked (e.g., by potential customers visiting the host website). Websites utilizing the PPC model, whether it involves regular PPC advertisements (e.g., text advertisements, electronic coupon advertisements, or both, may typically launch a PPC campaign based on keyword matching (i.e., also referred to as “sponsored match”), or based on content matching. Keyword based PPC campaigns display advertisements when keyword queries (e.g., inputted into search engines) are correlated with a keyword list of the advertiser, whereas content based PPC campaigns display advertisements on publisher websites and e-mails. Systems that employ electronic coupons and other electronic advertisements (e.g., banner advertisements, text advertisements) allow advertisers, marketers, and web publishers to strategically place electronic coupons and other advertisements at specific web pages of websites for the purposes of promoting, selling, distributing, or calling a product or service to the attention of the public. In traditional electronic advertising systems, however, the layout or scheme (i.e., the graphical design, or “look”) of the electronic advertisements that are advertised on a host website of a particular web publisher may not be consistent with the layout or scheme employed by that host website. This particular lack of consistency may degrade the overall appearance of the website, which may lead the host website to loose credibility and may also create a sense of over-commercialism. To further illustrate this, reference is now made to FIG. 1, which is a prior art schematic diagram, generally referenced 10, showing scheme mismatch relationships of various agents employing electronic coupon and electronic text advertisements.

A web page 12, hosted by a website (not shown) of web publisher 1 employs a characteristic scheme 14 (i.e., a layout, graphical design, appearance or presentation), is represented by a specific string of characters (i.e., “A B C”) having a particular font. Web page 12 includes an advertising section 16 that includes a plurality of electronic text advertisements 18 and 20, and electronic coupons 22, 24 and 26. It is noted that the characters themselves represent the particular concept, content or target of the website, whereas the font of the characters represent the particular design scheme employed by that website. A web page 28 of web publisher 2 employs a characteristic scheme 30 and includes an advertising section 32. Advertising section 32 includes a plurality of electronic text advertisements 34 and 36, and electronic coupons 38, 40, and 42. A web page 44 of web publisher 3, affiliated with web publisher 1 employs a characteristic scheme 46 and includes an advertising section 48, which includes in turn, a plurality of electronic text advertisements 50 and 52, and electronic coupons 54, 56 and 58. A web advertiser that is not a web publisher, advertises articles, services, and the like, has a plurality of electronic text advertisements 60 and 62, and electronic coupons 64, 66 and 68. The following will present, three simplified exemplary cases of scheme mismatch occurring in the interaction between various agents employing electronic coupon and electronic text advertising.

Suppose for example, the web advertiser advertises product “H” by placing corresponding electronic text advertisement 62 and electronic coupon 66 in advertising section 16 of web page 12 of web publisher 1. These processes are shown respectively by lines 70 and 72. Electronic text advertisement 62 for product “H” is embedded into the web page of web publisher 1 as electronic text advertisement 20 and characterized as having the same content (i.e., represented by usage of the same character) and the same scheme (i.e., represented by usage of the same font type) of that employed by the web advertiser. Similarly, electronic coupon 66 (associated with product “H”) is embedded into the web page of web publisher 1 as electronic coupon 22 and also characterized as having the same content and scheme of that employed by the web advertiser. Although the embedding preserves both the content and scheme employed by the web advertiser, this scheme is inconsistent with characteristic scheme 14, employed by web publisher 1. In a similar manner, electronic coupon 64, corresponding to service “G” is embedded as electronic coupon 38 into advertising section 32 of web page 28 of web publisher 2 (shown by line 74). The scheme of electronic coupon 38 is inconsistent with characteristic scheme 30, employed by web publisher 2.

Another example involves two different web publishing websites reciprocally placing electronic text advertisements and electronic coupons in the advertising section of the other web publishing website. Suppose web publisher 1 places electronic text and electronic coupon advertisements into advertising section 32 of web page 28 of web publisher 2, which are embedded as electronic text advertisement 36 and electronic coupon 40, respectively (these placements are indicated by lines 76, 78, respectively). Suppose conversely, that web publisher 2 places electronic text and electronic coupon advertisement into advertising section 16 of web page 12 of web publisher 1, which are embedded as electronic text advertisement 18 and electronic coupon 26 respectively (placements indicated by lines 80, and 82, respectively). Following this cross-placement and embedding, the schemes of the electronic text advertisement and electronic coupons remain incoherent with the schemes employed by the websites to which they were respectively embedded in.

A further example involves the use of affiliate marketing for the placement of electronic text and electronic coupons advertisements from a first web publisher into the advertising section of a web page of a second web publisher via a third web publisher, the latter being affiliated with the first web publisher. Suppose for example, web publisher 1, places an electronic text advertisement and an electronic coupon, embedded as electronic text advertisement 50 and electronic coupon 58, respectively, into web page 44 of web publisher 3 that is affiliated with web publisher 1. These placements are indicated by line 84. Alternatively, as an affiliate of web publisher 1, web publisher 3 may opt not to actually embed the electronic text advertisement and electronic coupon into its web page 44. Now suppose further, that web publisher 3 places electronic text advertisement 50 and electronic coupon 58 into advertising section 32 of web page 28 of web publisher 2. These are then embedded as electronic text advertisement 34 and electronic coupon 42, respectively (indicated by lines 86 and 88, respectively). In this case as well, even when an intermediary is employed (i.e., web publisher 3), characteristic scheme 14 of web publisher 1 is preserved in electronic text advertisement 34 and electronic coupon 42 of web page 28 of web publisher 2, and this consequently results in scheme mismatch, with regard to characteristic scheme 30, employed by web publisher 2.

### SUMMARY OF THE DISCLOSED TECHNIQUE

It is the object of the disclosed technique to provide a novel method and system for providing electronic advertisements to a client system via a server system such that the electronic advertisements advertised by advertisers on a host website of the client system are consistent with the layout, or design scheme employed by the that host website. The system and method according to the disclosed technique facilitates distribution, sharing, customization, and management of electronic advertisements among those who are registered with the system (e.g., web publishers, web advertisers, affiliates, and the like).

In accordance with the disclosed technique, there is thus provided a method for providing an electronic advertisement to a client system via a server system. The server system is coupled with an electronic advertisement database for storing a plurality of electronic advertisement data structures that each defines a respective electronic advertisement. Each electronic advertisement data structure attributes at least one advertising field designation to each respective electronic advertisement. The client system that hosts a client website employs a characteristic design scheme. The method includes the procedures of establishing communications between the server system and the client system, registering the client system with the server system, providing a retrieval and adaptation object from the server system to the client system, integrating the retrieval and adaptation object into the client website, retrieving by the retrieval and adaptation object the electronic advertisement data pertaining to the respective electronic advertisement from the electronic advertisement database, according to at least one advertising field designation, and incorporating the electronic advertisement into the client webpage, by substantially adapting the retrieved electronic advertising data of the respective the electronic advertisement, to substantially correspond with the characteristic design scheme.

According to another aspect of the disclosed technique, there is thus provided a system for providing an electronic advertisement to a client system. The client system hosts a client website employing a characteristic design scheme. The system includes an electronic advertisement database, for storing a plurality of electronic advertisement data structures that each defines a respective electronic advertisement, a server system coupled with the electronic advertisement database, and a retrieval and adaptation object. Each electronic advertisement data structure attributes at least one advertising field designation to each respective electronic advertisement. The server system and the client system establish communications therebetween, and the server system registers the client system. The server system provides the retrieval and adaptation object to the client system and the client system integrates the retrieval and adaptation object into the client website. The retrieval and adaptation object retrieves electronic advertisement data pertaining to the respective electronic advertisement from the electronic advertisement database, according to at least one advertising field designation. The retrieval and adaptation object incorporates the electronic advertisement into the client webpage by adapting the retrieved electronic advertising data of the respective electronic advertisement, to substantially correspond with that characteristic design scheme.

### BRIEF DESCRIPTION OF THE DRAWINGS

The disclosed technique will be understood and appreciated more fully from the following detailed description taken in conjunction with the drawings in which:

FIG. 1 is a prior art schematic diagram, showing scheme mismatch relationships of various agents employing electronic coupon and electronic text advertisements;

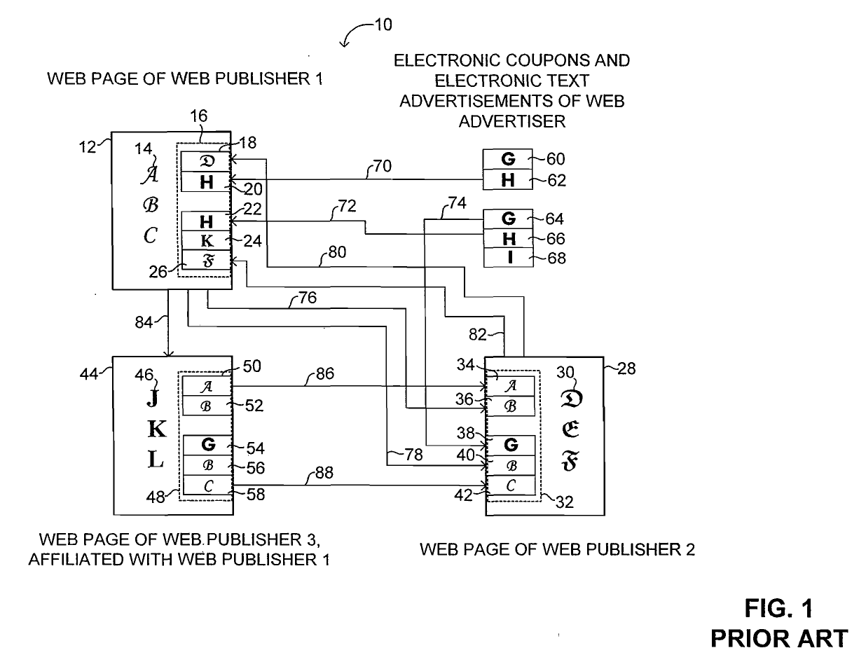

FIG. 2 is a schematic illustration of a client-server architecture implementing an electronic advertising platform, constructed and operative in accordance with an embodiment of the disclosed technique;

FIG. 3 is a schematic illustration depicting a representative selection of advertisement categories and their relation with a plurality of web page sections of a web publisher website;

FIG. 4 is a schematic illustration depicting distribution and sharing of electronic advertisements among those who are registered with the electronic advertising platform;

FIG. 5A is a schematic illustration of a method for providing an electronic advertisement to a client system via a server system; and

FIG. 5B is a continuation of the schematic illustration of the method from FIG. 5A.

### DETAILED DESCRIPTION OF THE EMBODIMENTS

The disclosed technique overcomes the disadvantages of the prior art by providing a system and method for enabling the retrieval and adaptation of electronic advertisements into a client system via an electronic advertising platform (i.e., a server system). The server system is coupled with an electronic advertisement database, which stores a plurality of electronic advertisement data structures that each of which defines a respective electronic advertisement. Each electronic advertisement data structure attributes at least one advertising field designation to the respective electronic advertisement. The client website includes an advertising section, and employs a characteristic design scheme. The server system provides a retrieval and adaptation object to the client system where it is integrated into the client website (e.g., advertising sections thereof). The retrieval and adaptation object retrieves electronic advertising data pertaining to the respective electronic advertisement, from the electronic advertisement database, according to whether there is a substantial match between the advertising field designation of the electronic advertisements and the advertising fields associated with advertising sections in the client website. The retrieved electronic advertisements are incorporated into those advertising sections associated with the match, and are further adapted to match the characteristic design scheme of the client website.

According to the disclosed technique, the electronic advertising platform facilitates distribution, sharing, customization, and management of electronic advertisements among those who are registered with the system (e.g., web publishers, web advertisers, affiliates, and the like). Furthermore, clients such as web advertisers are provided with an ability to create, launch and promote electronic advertising campaigns in web publisher websites.

The method and system described herewith may either be implemented in discrete digital and analog components, or implemented in a computer system having a processor, memory and storage.

The disclosed technique relates to electronic advertisements in general and to electronic coupons advertisements, electronic banner advertisements, electronic text advertisements, and the like, in particular. Examples given throughout the detailed description that relate to a particular kind of electronic advertisement, apply substantially to the other types of electronic advertisements.

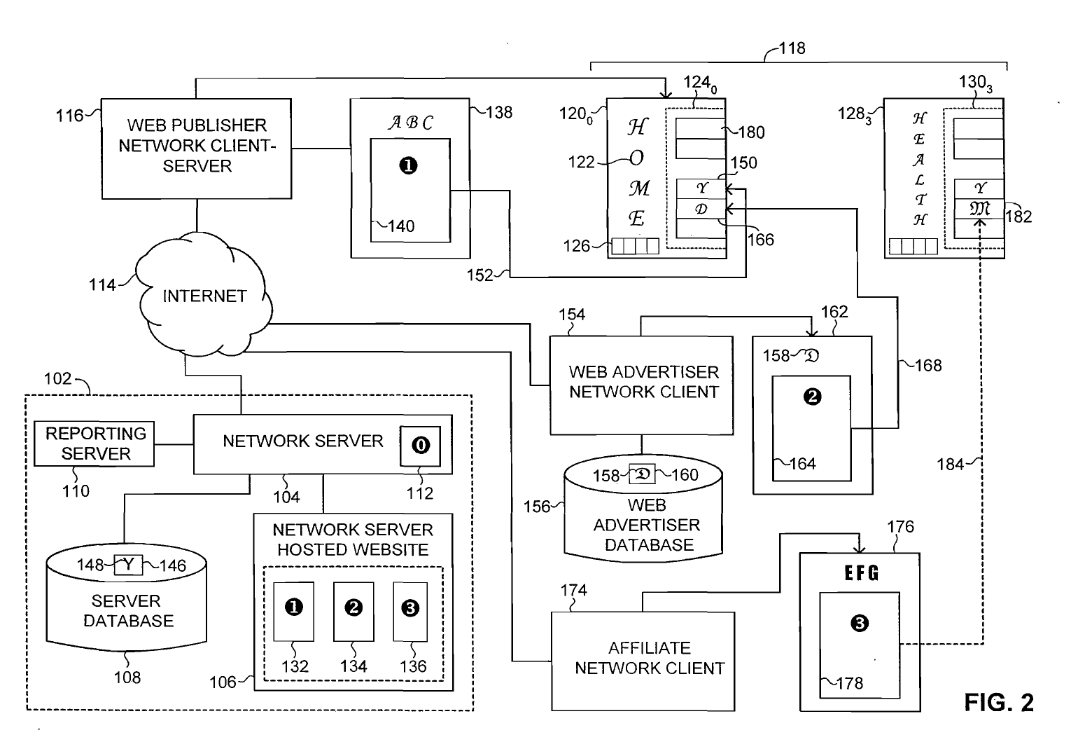

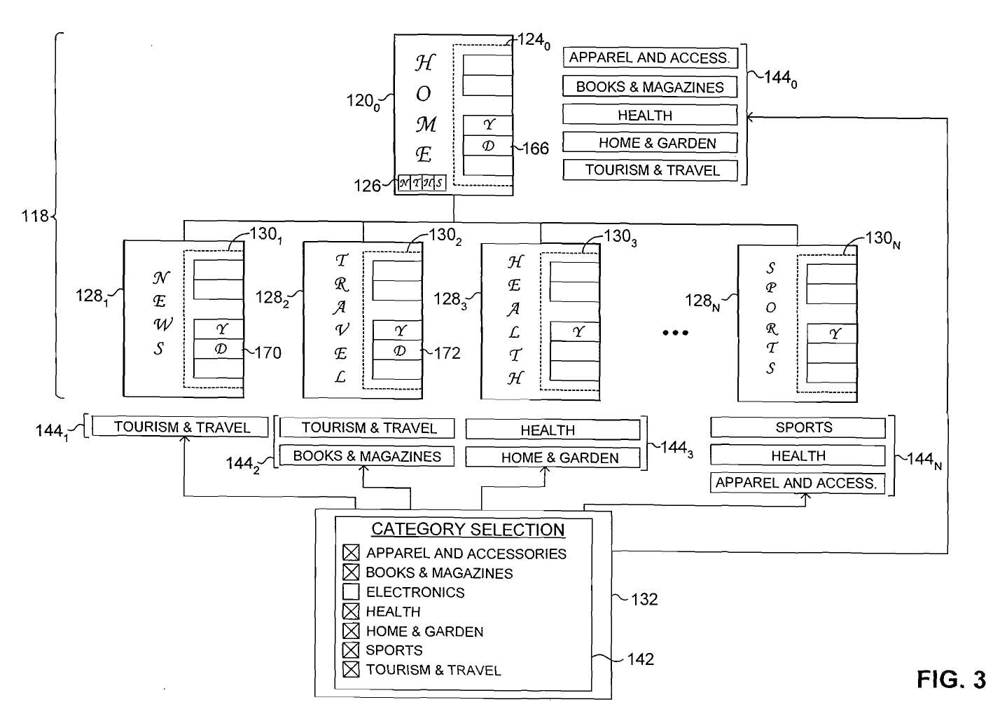

Reference is now made to FIG. 2, which is a schematic illustration of a client-server architecture implementing an electronic advertising platform, generally referenced 100, constructed and operative in accordance with an embodiment of the disclosed technique. Electronic advertising platform 102 includes a network server 104 that hosts a network server website 106, a server database 108 (i.e., an electronic advertising database), and a reporting server 110. Network server 104 (i.e., a server system) operates a server program (not shown) and also includes an electronic advertising platform management system 112. Server database 108 and reporting server 110 are coupled with network server 104. Network server 104 is connected with the Internet 114 (i.e., or other computer network such as an intranet, extranet). Network server 104 is generally accessible by clients via Internet 114. The client-server architecture supports multiple connections between a plurality of clients and network server 104. As illustrated in FIG. 2, a web publisher network client-server 116 (i.e., of a web publisher), connects with network sever 104 via the Internet 114. Web publisher network client-server 116 hosts a web publisher website 118 that includes a web publisher homepage 120₀. Web publisher website 118 employs a characteristic web publisher scheme 122 (i.e., layout, graphical design, “look”, and the like). Web publisher homepage 120₀ includes an advertising section 124₀, and may include hyperlinks 126 to a plurality of main sections (i.e., channels) of web publisher website 118. Reference is now further made to FIG. 3, which is a schematic illustration depicting a representative selection of advertisement categories and their relation with a plurality of web page sections of a web publisher website.

FIG. 3 illustrates a general structure of web publisher website 118 including a plurality (i.e., an integer number, N) of main web page sections 128₁, 128₂, 128₃, and 128_{N}, which are accessible via hyperlinks 126 in web publisher homepage 120₀. Each of web page sections 128₁, 128₂, 128₃, and 128_{N}, includes respective advertising sections 130₁, 130₂, 130₃, and 130_{N}. Each of web page sections 128₁, 128₂, 128₃, and 128_{N} directs to distinct fields (i.e., subjects, topics) that feature subject-related content. For example, main section web page 128₁ displays content related to the news, whereas main section web page 128₂ features content related with the field of travel. Alternatively, web publisher website 118 may represent other types of websites that are directed to various fields, subjects and purposes (e.g., personal websites, search engine websites, academic websites, e-commerce websites).

With reference to FIG. 2, network server hosted website 106 of electronic advertising platform 102 hosts a plurality of web pages, which are accessed from a root Uniform Resource Locator (URL), or homepage. The homepage of network server hosted website 106 is organized according to a particular structure (e.g., hierarchical), which includes a web publisher customization and management section 132, a web advertiser customization and management section 134, and an affiliate customization and management section 136. Web publisher network client-server 116 accesses network server hosted website 106 via the Internet 114 through a client software program 138 (e.g., an Internet browser) using an application protocol (e.g., Hypertext Transfer Protocol (HTTP), Telecommunication Network (Telnet)) by sending a request to the server program. Network server 104 receives the request and establishes a communication session 140 with web publisher network client-server 116. Communication session 140 directs client software program 138 (i.e., the user thereof) to access web publisher customization and management section 132. Web publisher customization and management section 132 incorporates a user interface based on client-server communication architecture for enabling the customization, modification, and control of various aspects associated with electronic coupon advertisements, advertised in web publisher website 118. The user interface allows the web publisher to register with electronic advertising platform 102 via network server hosted website 106. Registration within the system (i.e., electronic advertising platform 102) entails setting up a web publisher account (not shown) by inputting particular details such as web publisher name, web publisher Internet address, method of payment (e.g., credit card details), the logo of the publisher, and specific advertising categories or fields (e.g., Home & Garden, Pets, Books, Apparel & Accessories, Tourism & Travel) that are of interest to the web publisher. The web publisher selects the type of the electronic advertisement (i.e., an electronic advertisement “program” or “track”), which is of interest (e.g., electronic coupons, electronic banners, electronic text, and the like). It is noted that the web advertiser may choose to engage in a plurality of electronic advertisement tracks, each being of different type. Each electronic advertisement program (or track) is defined by its respective electronic advertisement program data (e.g., features listed in Table 3 herein below). For simplification purposes, suppose for example, that electronic advertisements of electronic coupon type are of interest (i.e., the electronic coupon track). During communication session 140, the web publisher selects which categories (i.e., of products, services, accommodations) are to be advertised in advertising sections 124₀, 130₁, 130₂, 130₃, and 130_{N} (FIG. 3) of web publisher website 118 by those potential electronic coupon advertisements matching the selected categories of the web publisher. These categories may be classified according to content (e.g., thematic, substance). The selection of these categories is achieved via web publisher customization and management section 132, which directs to an advertising category selection graphical user interface (GUI) 142 (e.g., a window). For example, web publisher decides that electronic coupon advertisements relating to the fields of tourism & travel are to be placed in advertising section 124₀ (i.e., corresponding to the homepage), advertising section 130₀ (i.e., corresponding to the “news” section web page) and advertising section 130₂ (i.e., corresponding to the “travel” section web page) (FIG. 3).

Network server 104 (FIG. 2) provides (e.g., transfers, whether directly or indirectly via a third party, and the like) a retrieval and adaptation object (not shown) to web publisher network client-server 116. This retrieval and adaptation object is integrated into web publisher website 118, according to the preferences of the web publisher (e.g., choice of web page sections that are to be included in the integration). The retrieval and adaptation object may be an Extensible Markup Language (XML) file, a HyperText Markup Language (HTML) element such as an Inline Frame (IFrame), and the like. The retrieval and adaptation object enables the web publisher homepage 120₀ and each web page section that integrates the retrieval and adaptation object (i.e., or derivatives thereof), to automatically receive from network server 104, electronic coupon advertisement data from those categories that match the selections made by the web publisher for each respective web page section. For example, web publisher integrates the retrieval and adaptation object into web page section 128_{N} (i.e., corresponding to the “sports” section) and selects via the user interface of web publisher customization and management section 132 to receive electronic coupon advertisements relating to sports, health, and apparel & accessories (FIG. 3). This selection by the web publisher is indicated by reference number 144_{N}. Similarly, other example selections by the web publisher associated with web publisher homepage 120₀, and web page sections 128₁, 128₂, and 128₃ are shown in FIG. 3 and indicated, respectively, by reference numbers 144₀, 144₁, 144₂, and 144₃.

The user interface of web publisher customization and management section 132 enables a user (not shown) to customize, modify, and control various aspects associated with the electronic coupons. Table 1 outlines various representative features in the user interface of web publisher customization and management section 132.

TABLE 1
Outline of representative features in the user interface
of web publisher customization and management section 132

| | |
|---|---|
| Web publisher website | Display of existing websites and their |
| management | website sections classified according to: |
| | Section/channel name |
| | Display of retrieval and adaptation object |
| | code (i.e., source code) |
| | Dates and times of each operation (e.g., |
| | registration) |
| Addition of new | Website/website section name, designation |
| website/website section | Selection of web advertising categories per |
| | website/website section |
| | Display of electronic coupons that are |
| | currently associated with each |
| | section/channel |
| Modification (editing) and | Website/website section settings |
| deletion of | Retrieval and adaptation object code editor |
| website/website section | (per website section) |
| | Website/website section modification and |
| | deletion |
| Website/website section | For each website/website section: |
| report/s | Total number of times an advertisement |
| | (e.g., electronic coupon) has been displayed |
| | Number of times an advertisement has been |
| | clicked |
| | The ratio of the number of times an |
| | advertisement has been displayed to the |
| | number of times it has been clicked |
| Financial data | Balance due (debt) that is owed |
| | Billing status and information |
| | Payment history details |
| | List of PPC flat-rates per electronic coupon |
| | advertised in each webpage section |
| | List of bid-based PPC information per |
| | electronic coupon advertised in each |
| | webpage section |
| | Financial data statistics and settings (e.g., |
| | financial statistical analysis) |
| | Commission rates for third-party retrieval of |
| | electronic advertisements from the catalog* |
| Auxiliary | Uploading of publisher logo |
| | Modification of publisher logo settings |

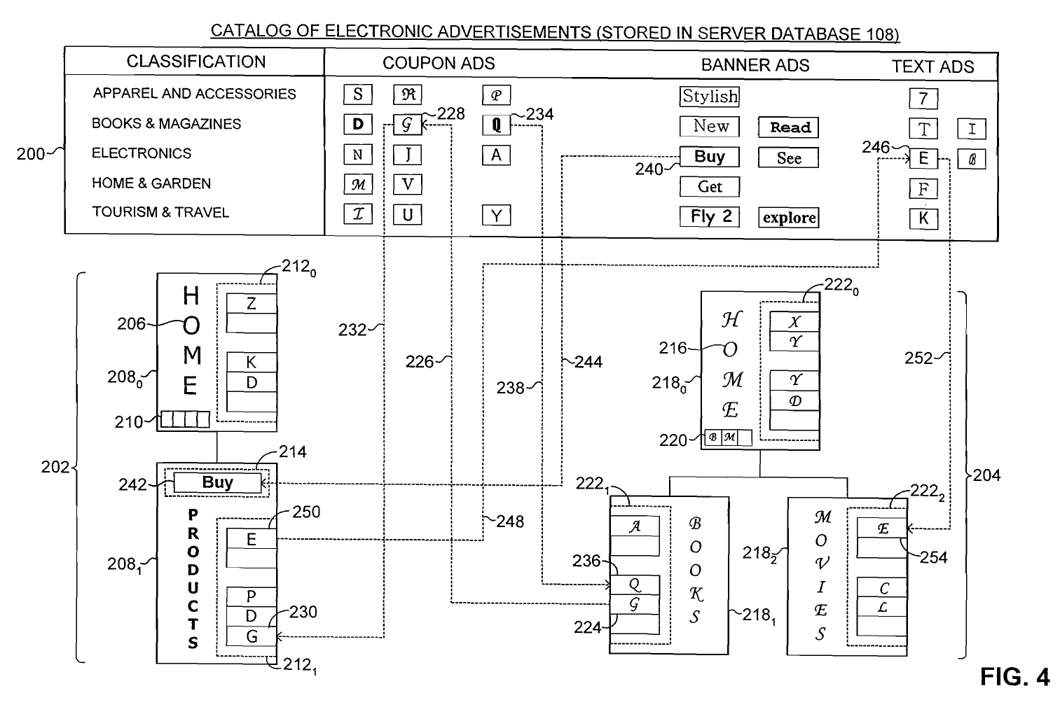

*Described in connection with FIG. 4

In accordance with Table 1, the user interface of web publisher customization and management section 132 can display all registered websites with their website sections, classified according to section (i.e., channel) name, the dates and times of each operation (e.g., registration), as well as to display of the retrieval and adaptation object code. Additional features of the user interface of web publisher customization and management section 132 include the addition of new websites and sections thereof, modification (i.e., editing) and deletion of registered data associated with a website and a section thereof, management of website section reports, and management of financial data. Features relating to the management of financial data include, for example, a list of bid-based PPC information and a list of PPC flat-rates per electronic coupon that is advertised in each webpage section. Other features enable web publishers to upload their publisher logos into electronic advertising platform 102. Additional features are tabulated in Table 1.

Electronic advertising platform 102 enables the adaptation of electronic coupons, such that they match the characteristic scheme of the web publisher. Suppose, for example, that web publisher homepage 120₀ integrates the retrieval and adaptation object (i.e., or derivatives thereof), and that server database 108 stores an electronic coupon 146 (FIG. 2), which is to be placed in advertising section 124₀. Suppose further that electronic coupon 146 employs a different characteristic scheme 148 from characteristic scheme 122, employed by the web publisher. When electronic coupon 146 is transferred (i.e., electronic coupon data thereof) to web publisher homepage 120₀ and incorporated into advertising section 124₀, as electronic coupon 150 (i.e., process indicated by line 152), it is adapted such that its characteristic scheme 148 matches characteristic scheme 122 of the web publisher. While the characteristic scheme changes, the content (i.e., particular fields in an electronic coupon data structure) is preserved. Table 2 outlines basic representative fields, which may comprise an electronic coupon data structure.

TABLE 2
Outline of basic representative fields comprising
an electronic coupon data structure

Coupon offer/title
Company identifier
Coupon scheme (including sub-fields)
Contact information
Coupon serial number
Coupon issue date (timestamp)
Coupon expiration date
Coupon classification/field designation (i.e.,
according to categories, fields, subjects)

In view of the example above, only data within the “Coupon scheme” field and subfields thereof are changed in an electronic coupon data structure (not shown) of electronic coupon 146. Moreover, electronic advertising platform 102 enables the web publisher to customize particular aspects (e.g., coupon design schemes) relating to those electronic coupons, which are integrated, and embedded within the web publisher advertising section.

According to the disclosed technique, by employing electronic advertising platform 102, web advertisers are provided with an ability to launch and promote electronic coupon advertising campaigns in web publisher websites. Furthermore, as will be demonstrated herein below, electronic advertising platform 102 facilitates the distribution of web advertiser electronic coupons among various web publisher websites that are registered with the system.

With reference to FIG. 2, a web advertiser (not shown) employs a web advertiser network client 154 to connect with network server 104 via the Internet 114. Web advertiser may further employ a web advertiser database 156 that is coupled with web advertiser network client 154. Web advertiser database 156 stores data pertaining to a plurality of electronic coupons intended for being advertised in various web publisher websites. Suppose for example, the web advertiser, employing a characteristic scheme 158, wishes to advertise an electronic coupon 160, relating to product “D”. For this purpose, web advertiser network client 154 accesses network sever hosted website 106 via the Internet 114 through a client software program 162 (i.e., similar to client software program 138). Web advertiser network client 154 establishes a communication session 164 with network server 104 via the Internet 114 and accesses web advertiser customization and management section 134 of electronic advertising platform 102. Web advertiser customization and management section 132 incorporates a user interface for customizing, modifying, and controlling various aspects (detailed below) associated with the electronic coupons. The web advertiser opens a web advertiser account (not shown) in the system of electronic advertising platform 102. Network server 104 interrogates web advertiser network client 154 for web advertiser information such as the type of advertising campaign web advertiser wishes to launch, the advertising campaign name, dates of initiation and termination of the advertising campaign, electronic coupon information per advertising campaign, campaign budget, the cost per click according to a flat-rate based model or a bid-based model. This web advertiser information, including the data pertaining to electronic coupon 160 is stored in server database 108. Table 3 outlines representative features that are accessible and modifiable (where applicable) in the user interface of web advertiser customization and management section 134 relating to electronic coupon advertisements and PPC advertisements. It is noted that the advertiser may opt to launch a plurality of advertising campaigns (e.g., simultaneously), where each such advertising campaign may run a plurality of electronic coupon advertisements.

TABLE 3
Outline of representative features in the user interface of
web advertiser customization and management section 134

| Campaign management | Display of all existing advertising campaigns | |
|---|---|---|
| | classified according to: | |
| | Campaign name | |
| | Campaign initiation date and termination | |
| | date | |
| | Financial data summary per campaign | |
| Creation of new | Campaign name, designation | |
| campaign | Campaign initiation date and termination | |
| | date | |
| | Contact information | |
| | Campaign settings | |
| | Budget per fiscal period (e.g., month, year) | |
| | Threshold account balance sum for sending | |
| | notification | |
| Campaign report/s | Campaign running time | |
| | Total number of views per campaign | |
| | Number of times an advertisement (e.g., | |
| | electronic coupon) has been displayed | |
| | Number of times an advertisement has been | |
| | clicked | |
| | The click-through rate (CTR) - the ratio of | |
| | the number of users who clicked on an | |
| | advertisement to the number of times the | |
| | advertisement was delivered (e.g., | |
| | displayed) (Reporting server 110 may be | |
| | employed to calculate the CTR.) | |
| Modification (editing) | Campaign settings | |
| and deletion of | Update campaign information | |
| campaign | Campaign modification and deletion | |
| Creation of new | 1. | Electronic coupon general information |
| electronic coupon (per | | settings |
| campaign) | | Coupon name, designation |
| | | Coupon offer description |
| | | Coupon issue date (e.g., via timestamp) |
| | | Coupon expiration date |
| | | Coupon cost per click |
| | 2. | Coupon design scheme |
| | | Coupon vector graphics editing (e.g., use |
| | | of geometrical object primitives such as |
| | | curves, lines, circles, and text related |
| | | features (e.g., content, font, color), |
| | | alteration of size, position and |
| | | orientation). |
| | | Coupon graphical embedding (e.g., |
| | | embedding images such as logos, |
| | | embedding graphics according to |
| | | template, clip-art) |
| | | Coupon bitmap editing (e.g., use of fill |
| | | patterns, textures, image processing |
| | | features (e.g., sharpening, color |
| | | adjustments, brush techniques) |
| | 3. | Coupon categorization |
| | | Sorting coupons according to specific |
| | | advertising categories and fields |
| | | Display, modification (e.g., selection, |
| | | de-selection, deletion) of advertising |
| | | categories and fields attributed to |
| | | particular coupon |
| | | Categorization settings |
| | 4. | Coupon schedule |
| | | Coupon display calendar (i.e., |
| | | determines when a coupon is displayed |
| | | and the duration (e.g., according to date |
| | | and time) |
| | | Coupon issue date (e.g., timestamp) |
| | | Display settings and statistics |

| | |
|---|---|
| Modification (editing) | Features substantially similar to those in |
| and deletion of | See “Creation of new electronic coupon” |
| campaign | hereinabove |
| Campaign financial | PPC flat-rates per campaign and per |
| data | coupon |
| | Bid-based PPC information per campaign |
| | and per coupon |
| | Balance due (debt) that is owed per |
| | campaign |
| | Quality index per electronic coupon and |
| | corresponding formula thereof |
| | Payment history details |
| | Financial data statistics and settings (e.g., |
| | financial statistical analysis) |
| | Commission rates for third-party retrieval of |
| | electronic advertisements from the catalog* |

*Described in connection with FIG. 4

Representative features in the user interface of web advertiser customization and management section 134, outlined in Table 3, include the management of advertising campaigns, the creation of new advertising campaigns, the compilation of advertising campaign reports, the modification and deletion of advertising campaigns, the creation of new electronic coupons (per advertising campaign), the modification and deletion of electronic coupons, and the management of campaign financial data. For example, features relating to the creation of new electronic coupons include the management of general information settings (e.g., coupon name, coupon offer description), management of the coupon design scheme, categorization management of coupons, and coupon schedule management (e.g., coupon issue date, duration of display). Additional features are tabulated in Table 3.

Returning to the example above, electronic coupon 160 employing characteristic scheme 158, is integrated and embedded into advertising section 124₀ as electronic coupon 166, (indicated by a line 168), having characteristic scheme 122. The web advertiser, utilizing the user interface of web advertiser customization and management section 132, may customize various aspects associated with electronic coupon 166, such as the relevant of those features, tabulated in Table 3. Alternatively, besides integration and embedding into web publisher homepage 120₀, electronic coupon 160 may be also integrated and embedded into various web page sections of web publisher website 118, according to whether there is a match between the field classification defined for electronic coupon 160 and those categories preselected by the web publisher for each respective web page section. For example, if the coupon field classification in the data structure (not shown) of electronic coupon 160 is set to “tourism & travel”, then electronic coupon 160 will be integrated and embedded in web publisher web page sections 128₁ and 128₂ (FIG. 3) as electronic coupons 170 and 172, respectively.

Electronic advertising platform 102 determines the cost per click (CPC) for each PPC advertisement (e.g., coupon advertisement, banner, text) according to various models, among which include, for example, the bid-based model, the flat-rate model, and the like. According to the bid-based model, a plurality of web advertisers (not shown) compete against each other in an auction, where each one attempts to gain favored placement locations for their electronic coupon advertisements, in the advertising sections of a particular web publisher website. Favored placement locations for electronic coupons are generally those locations in an advertising section that provide higher likelihood of interaction (e.g., clicks, exposure) with potential consumers that visit the web publisher website. Typically, placement locations are ranked in descending order from the most favorable to the least favorable. A favored location for advertisers may be, for example, a top position 180 (FIG. 2) in the advertising list within advertising section 124₀ of web publisher homepage 120₀. The web advertiser inputs via web advertiser customization and management section 134 a ceiling price that the web advertiser is willing to pay (i.e., makes a bid) for each electronic coupon. Generally, the electronic coupon with the highest associated bid has the highest rank and therefore, gains the most favored placement location in the advertising section.

According to the flat-rate model, the web publisher and web advertiser both agree upon a preset amount to be paid for each electronic advertisement that is clicked and for each advertising campaign (see Campaign financial data in Table 3). Alternatively, electronic advertising platform 102 may additionally employ a quality-based bidding model, where to each electronic advertisement there corresponds a quality index that rates the electronic advertisement according to various attributes (e.g., CTR, landing page quality). According to this model, electronic advertising platform 102 determines the order in which the electronic advertisements are to be listed (i.e., ranked) according to a particular formula. An example of such a formula is the bid multiplied by the quality index.

According to the disclosed technique, by employing electronic advertising platform 102, affiliates of web advertisers and web publishers are provided with an ability to generate revenue and to be compensated for their marketing efforts in drawing customers, or potential customers to the websites of web publishers, and to the content (e.g., products) provided by the web advertisers. For example, if an affiliate who is affiliated with a particular web publisher redirects potential customers to the website of that web publisher, then that affiliate, registered with electronic advertising platform 102, will be compensated (i.e., rewarded) by that web publisher by a commission. In a similar manner, an affiliate who is affiliated with a particular web advertiser will also be compensated. In this respect, the affiliate can act as a retailer or e-tailer. Examples of e-tailers include comparison shopping websites, online retailing (e-commerce) websites that sell products from various manufacturers, and the like. Referring back to FIG. 2, an affiliate (not shown) employs an affiliate network client 174 to connect with network server 104 via the Internet 114. In addition, the affiliate may also employ an affiliate website (not shown), which hosts advertising content that spurs visitors of the affiliate website to proceed to other websites in affiliation with the affiliated website.

Affiliate network client 174 accesses web publisher network client-server 116 via the Internet 114 through a client software program 176 (e.g., similar to client software program 162). Affiliate network client 174 establishes a communication session 178 with network server 104 via the Internet 114 and accesses affiliate customization and management section 136 of electronic advertising platform 102. Affiliate customization and management section 136 incorporates a user interface for managing various aspects associated with the management of various types of affiliate marketing programs provided by electronic advertising platform 102. Examples of affiliate marketing programs include web publisher affiliate marketing (whereby the affiliate is affiliated with a web publisher), web advertiser affiliate marketing (whereby the affiliate is affiliated with a web advertiser), affiliate-to-affiliate marketing (whereby the affiliate is affiliated with another affiliate), and the like.

During communication session 178 the affiliate opens an affiliate account (not shown) in the system of electronic advertising platform 102. Network server 104 interrogates the affiliate for affiliate-related information, such as the names of the visitors referred by the affiliate to register with the system, the commission rates per particular affiliate marketing program and per affiliate, conversion rates, dates of initiation and termination per affiliate marketing program, and the like. Table 4 outlines representative features in the user interface of affiliate customization and management section 136.

TABLE 4
Outline of representative features in the user interface
of affiliate customization and management section 136

| | |
|---|---|
| Affiliate marketing | Display of all existing affiliate marketing |
| program management | programs classified according to: |
| | Affiliate Name |
| | Name of invitee drawn into the system by |
| | the affiliate |
| | Type of affiliation (e.g., publisher, |
| | advertiser, affiliate) |
| | Initiation date and termination date per |
| | affiliate marketing program |
| | Financial data summary per affiliate |
| | marketing program |
| Creation of new affiliate | Affiliate program name, designation |
| marketing program | Affiliate program type |
| | List of invitees drawn into the system per by |
| | current affiliate marketing program |
| | Affiliate program initiation date and |
| | termination date |
| | Contact information |
| | Affiliate marketing program settings |
| Affiliate marketing | Affiliate marketing program running time |
| program report/s | Total number of invitees drawn into the |
| | system according to name |
| | Total number of advertising campaigns |
| | running, per invitee, drawn into the system |
| | by affiliate |
| | Campaign running time per advertising |
| | campaign |
| | Total number of advertisements placed per |
| | campaign (organized according to |
| | advertisement type, name) |
| | Number of times an advertisement has been |
| | displayed |
| | Number of times an advertisement has been |
| | clicked |
| Modification (editing) | Affiliate marketing program settings |
| and deletion of | Update affiliate marketing program |
| affiliate marketing | information |
| program | Affiliate marketing program modification and |
| | deletion |
| Financial data | Compensation methods and per affiliate |
| | marketing program and per invitee that is |
| | drawn into the system by the affiliate |
| | Pay per sale (PPS) (i.e., revenue sharing), |
| | Pay per action (PPA), PPC, and the like. |
| | Commission rates per invitee that is drawn |
| | into the system by the affiliate according to |
| | particular compensation method that is |
| | used. |
| | Financial data history |
| | Financial data statistics and settings (e.g., |
| | financial statistical analysis) |

Representative features in the user interface of affiliate customization and management section 136, outlined in Table 4, include the management of the affiliate marketing program, the creation of new affiliate marketing programs, compilation of affiliate marketing program reports, modification and deletion of affiliate marketing programs, and the management of financial data associated with its respective affiliate marketing program. Affiliate customization and management section 136 enables an affiliate to create a plurality of affiliate marketing programs (not shown) that can be of different type, and to manage them simultaneously. Each affiliate marketing program that is created by the affiliate is associated with a particular invitee that is referred to and drawn into the system by the affiliate. For example, the affiliate can create a web advertiser marketing program (not shown) under the name of a web advertiser (not shown), who is invited to register with the system of electronic advertising platform 102. When the web advertiser, referred to by the affiliate, accesses web advertising platform 102 via a web advertiser network client (not shown—in a similar manner, as described above in relation to web advertiser network client 154), and creates a new web advertiser account, the affiliate is notified. Alternatively, affiliate customization and management section 136 issues a verification code to the affiliate whereupon it is utilized by the invitee as a referral identifier during registration with electronic advertising platform 102.

More specifically, suppose for example that the affiliate is affiliated with the web advertiser that manufacturers medical and health related products and that this web advertiser wishes to place electronic coupon advertisements relating to such products in advertising section 130₃ (FIG. 2) of web page section 128₃, (i.e., featuring health related content). The web advertiser uses electronic advertising platform 102 to place an electronic coupon advertisement (indicated by the letter “M”) into advertising section 130₃, embedded therein as electronic coupon 182. The placement of electronic coupon 182 in advertising section 130₃ is indicated by a dotted line 184, signifying that the affiliate partook in this process. The affiliate is compensated for efforts made in drawing the web advertiser (i.e., the invitee) into the system of electronic advertising platform 102. Table 4 lists various types of compensation methods that may be employed by electronic advertising platform 102. For example, the affiliate and the web advertiser may agree upon a compensation method based on the PPC model, whereby for each web advertiser-created electronic coupon that is clicked, the affiliate receives a commission. Electronic advertising platform 102 enables the use of various types of compensation methods (partly listed in Table 4), and further enables the affiliate (i.e., and other parties involved) to set the commission rates according to the particular compensation method that is employed.

According to the disclosed technique, electronic advertising platform 102 facilitates the distribution and sharing of electronic advertisements among those who are registered with the system. The distribution and sharing of electronic advertisements will now be described in conjunction with FIG. 4, which is a schematic illustration depicting distribution and sharing of electronic advertisements among those who are registered with electronic advertising platform 102. FIG. 4 illustrates a simplified representation of a catalog of electronic advertisements 200 stored in server database 108. This catalog of electronic advertisements 200 (hereinafter referred as “catalog”) is a database containing data structures (not shown) of a plurality of electronic advertisements from different entities (e.g., web publishers, web advertisers, and the like) organized according advertisement type (i.e., electronic coupon advertisements, banner advertisements, text advertisements, and the like). The data structures of the respective electronic advertisements, stored within this catalog, are represented in FIG. 4 by rectangular-shaped electronic advertisement representations. Each electronic advertisement is classified according to subject or field to which it relates (e.g., books & magazines, automotive, and the like). For example, according to the simplified representation of this catalog, illustrated in FIG. 4, there are seven different electronic advertisements listed within the field classification of “books & magazines”. Specifically, there are three electronic coupon advertisements from different entities (i.e., differentiated by differing schemes), two electronic banner advertisements, and two electronic text advertisements.

FIG. 4 will now be described in greater detail through the use of example for the purpose of elucidating the disclosed technique. FIG. 4 illustrates a simplified schematic representation of the technique of distributing and sharing electronic advertisements between two entities using electronic advertising platform 102. Specifically, FIG. 4 illustrates two different web publisher websites 202 and 204 of two different web publishers (not shown). Web publisher website 202 employs a characteristic scheme 206 and includes a homepage 208₀ and a web page sub-section 208₁ that is accessible via hyperlinks 210, displayed on homepage 208₀. Homepage 208₀ and web page sub-section 208₁ include advertising sections 212₀ and 212₁, respectively. Web page sub-section 208₁ further includes a banner advertisement section 214. Web publisher website 204 employs a characteristic scheme 216 and includes a homepage 218₀ and two web page sub-sections 218₁ and 218₂ that are accessible from homepage 218₀ via hyperlinks 220. Homepage 218₀, and web page sub-sections 218₁ and 218₂ include advertising sections 222₀, 222₁, and 222₂, respectively. Each web publisher is registered with the system of electronic advertising platform 102, as described hereinabove in conjunction with FIGS. 2 and 3.

Suppose for example, the web publisher of web publisher website 204 creates an electronic coupon advertisement via web publisher customization and management section 132 (as described hereinabove in connection with FIG. 2) to be advertised in advertising section 222₁ as electronic coupon 224. The data structure (not shown) of electronic coupon 224 is stored and cataloged in the catalog (indicated by dotted line 226), and shown in FIG. 4 as electronic coupon representation 228. Once electronic coupon 224 is stored and cataloged (i.e., the data structure thereof) within the catalog, it may be shared with other web publishers that are registered with the system. Suppose further that the web publisher of web publisher website 202 has electronic coupons advertised in advertising section 212₁ and would like to obtain additional electronic coupon advertisements of the same category in order to fill empty advertising placement locations in advertising section 212₁. Electronic advertising platform 102 enables the web publisher of web publisher website 202 to automatically retrieve electronic advertisements from the catalog that match the preselected categories of the respective web page. For example, electronic coupon 224, represented by electronic coupon representation 228 in the catalog, is withdrawn by website section 208₁ and incorporated into advertising section 212₁ as electronic coupon 230 (indicated by dotted line 232). The scheme of electronic coupon 230 is adapted to correspond with characteristic scheme 206. Thus, electronic coupon 224 is shared and can further be distributed among various other web publisher websites that are registered with the system. Alternatively, the retrieval of particular electronic advertisements from the catalog may be allowed to only specific websites. For example, the electronic coupon represented in the catalog as electronic coupon representation 234 and classified under “books & magazines” is preordained exclusively for websites featuring content relating to books. Web page section 218₁ can therefore withdraw data pertaining to the electronic coupon advertisement represented by electronic coupon representation 234 from the catalog, and incorporate this electronic coupon into advertising section 222₁ as electronic coupon 236 (indicated by dotted line 238). The scheme of electronic coupon 236 is adapted to correspond with characteristic scheme 216. Generally, those who retrieve electronic advertisements from the catalog must pay fees (i.e., a commission) to the originator of those electronic advertisements. Web publishers and advertisers may set commission rates for third-party retrieval of electronic advertisements from the catalog (this feature is listed in Tables 1 and 3). It is noted that electronic advertisements may be attributed to a plurality of advertising field designations (i.e., classifications, for example, based on thematic content).

Electronic banner advertisements as well as electronic text advertisements may also be shared and distributed among entities, which are registered with the system. For example, an electronic banner advertisement, represented in the catalog by an electronic banner advertisement representation 240, is retrieved by the web publisher of web publisher website 202 and incorporated into banner advertisement section 214 as electronic banner advertisement 242 (indicated by dotted line 244). In another example, an electronic text advertisement, represented in the catalog by an electronic text advertisement representation 246, is created by the web publisher of web publisher website 202 (indicated by dotted line 248), and shown in advertising section 212₁ as electronic text advertisement 250. Subsequently, the web publisher of web publisher website 204 retrieves (indicated by dotted line 252) this electronic text advertisement (i.e., the data pertaining thereto) and incorporates it into advertising section 222₂ as electronic text advertisement 254 having a scheme which is consistent with characteristic scheme 216.

Electronic advertising platform management system 112 (FIG. 2) will now be described in greater detail. Electronic advertising platform management system 112 enables management of electronic advertising platform 102 and in particular, network server hosted website 106. Electronic advertising platform management system 112 is accessible to an administrator (not shown) of electronic advertising platform 102. Specifically, the administrator has access to web publisher customization and management section 132, web advertiser customization and management section 134, and to affiliate customization and management section 136. Table 5 outlines representative features in the user interface of electronic advertising platform management system 112. Representative features include content creation, management of network server hosted website 106, a search engine, user account information management, management of information pertaining to websites and website sections thereof including campaign reports, management of financial data, and administrator settings management. For example, in view of Table 5, network server hosted website content creation and management involves creation, modification and deletion of the content, appearance, dynamic interaction, and website coding. The administrator has control over the parameters of each of these features, such as the particular graphics employed, text style, format, scheme, and the like with regard to appearance. The search engine provides an interactive interface, which enables one to search through server database 108. Search terms (not shown) are inputted within searchable fields of the search engine. The searchable fields are at least partially listed in Table 5. Additional features in the user interface of electronic advertising platform management system 112 are also listed in Table 5.

TABLE 5
Outline of representative features in the user interface
of electronic advertising platform management system 112

| | |
|---|---|
| Network server hosted | Network server hosted website 106 web |
| website content creation | page (including the homepage) creation, |
| and management | modification, deletion of: |
| | Content: the information provided (text, |
| | media files, hyperlinks, and the like); |
| | Appearance: the graphics, text style, format, |
| | scheme, and the like; |
| | Dynamic interaction with visitors of the |
| | website: navigation, user interface settings, |
| | and the like; |
| | Website coding (including retrieval and |
| | adaptation object code editor): markup |
| | languages (e.g., Extensible Markup |
| | Language (XML)), databases (e.g., |
| | MySQL), sever-side scripting (e.g., PHP), |
| | client-side scripting (e.g., JavaScript), and |
| | the like. |
| Search Engine | Searchable criteria (via queries containing |
| | keywords, key numbers, Boolean operators, |
| | fields): |
| | Web publisher name, web advertiser name, |
| | affiliate name, account name, system |
| | identification number, contact information, |
| | web publisher/advertiser logo, account |
| | status (active/inactive), registration dates, |
| | website and website sections which |
| | incorporate the retrieval and adaptation |
| | object, field category selection per |
| | website/website section, advertising |
| | campaign name/designation, advertising |
| | campaign initiation and termination dates, |
| | campaign running time, advertising |
| | campaign budget, threshold account |
| | balance sum (or ranges of values) for |
| | sending notification, number of views per |
| | campaign, number of times advertisement |
| | has been displayed, clicked, CTR, |
| | advertisement association (to particular |
| | field), information stored within the |
| | advertisement data structure (see for |
| | example, Table 2), balance due, billing |
| | status, PPC flat-rates/bid rates, various |
| | financial data, commission rates, quality |
| | index, and the like. |
| User account (web | Modification, addition, deletion of: |
| publishers, web | Status (active/inactive), login name and |
| advertisers, affiliates) | password to account, user email address, |
| information | contact information, billing status and |
| | information |
| Website/website section | For each website/website section: |
| and campaign report/s | Total number of times an advertisement |
| | (e.g., electronic coupon) has been displayed |
| | Number of times an advertisement has been |
| | clicked |
| | The ratio of the number of times an |
| | advertisement has been displayed to the |
| | number of times it has been clicked |
| | For each advertising campaign: |
| | Campaign running time |
| | Total number of views per campaign |
| | Number of times an advertisement (e.g., |
| | electronic coupon) has been displayed |
| | Number of times an advertisement has been |
| | clicked |
| | The ratio of the number of times an |
| | advertisement has been displayed to the |
| | number of times it has been clicked |
| | The click-through rate (CTR) - the ratio of |
| | the number of users who clicked on an |
| | advertisement to the number of times the |
| | advertisement was delivered (e.g., |
| | displayed) |
| Financial data per user | Balance due (debt) that is owed |
| | Billing status and information |
| | Payment history details |
| | List of PPC flat-rates per electronic |
| | advertisement advertised in each webpage |
| | section (per advertisement type) |
| | List of bid-based PPC information per |
| | electronic advertisement advertised in each |
| | webpage section (per advertisement type) |
| | Financial data statistics and settings (e.g., |
| | financial statistical analysis) |
| | Commission rates for third-party retrieval of |
| | electronic advertisements from the catalog |
| | Minimum payment (without service |
| | commission) per web publisher, per web |
| | advertiser, and per affiliate |
| | Generated revenue per click per campaign |
| Administrator settings | Administrator password |
| | Email configuration |
| | Network server hosted website 112 settings |
| | Customer care (emails, preferences) |

The user interface of electronic advertising platform management system 112 allows the administrator to view the popularity index of particular electronic advertisements. The popularity index is determined according to the CTR that is associated with the electronic advertisement.

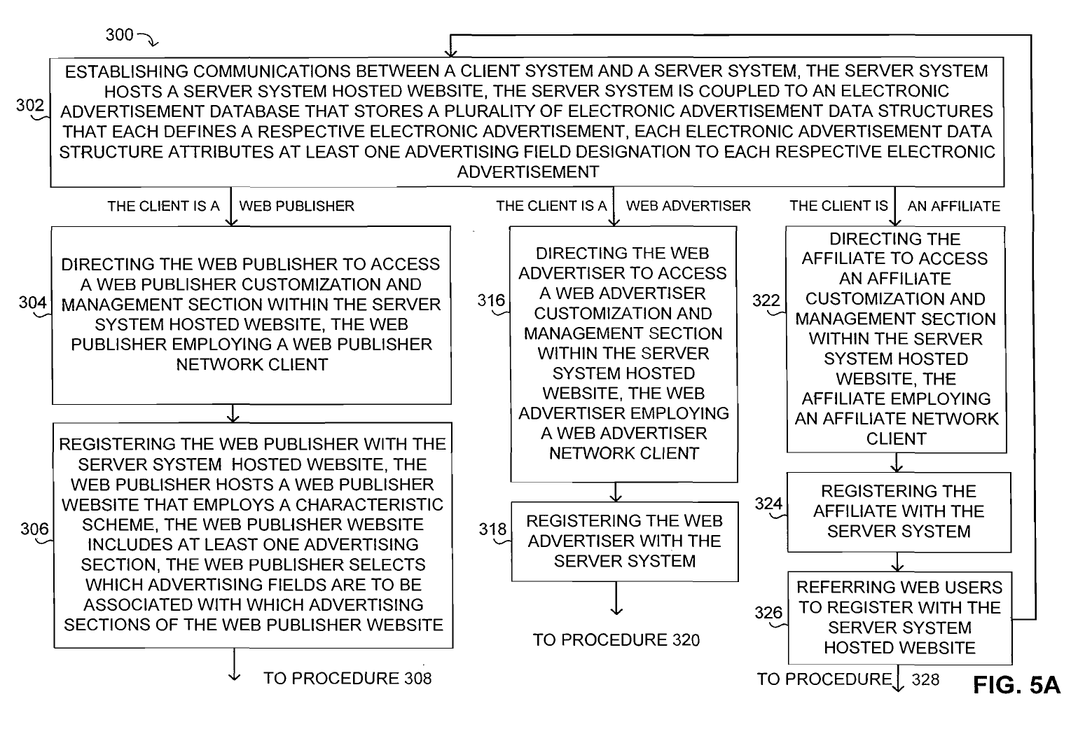

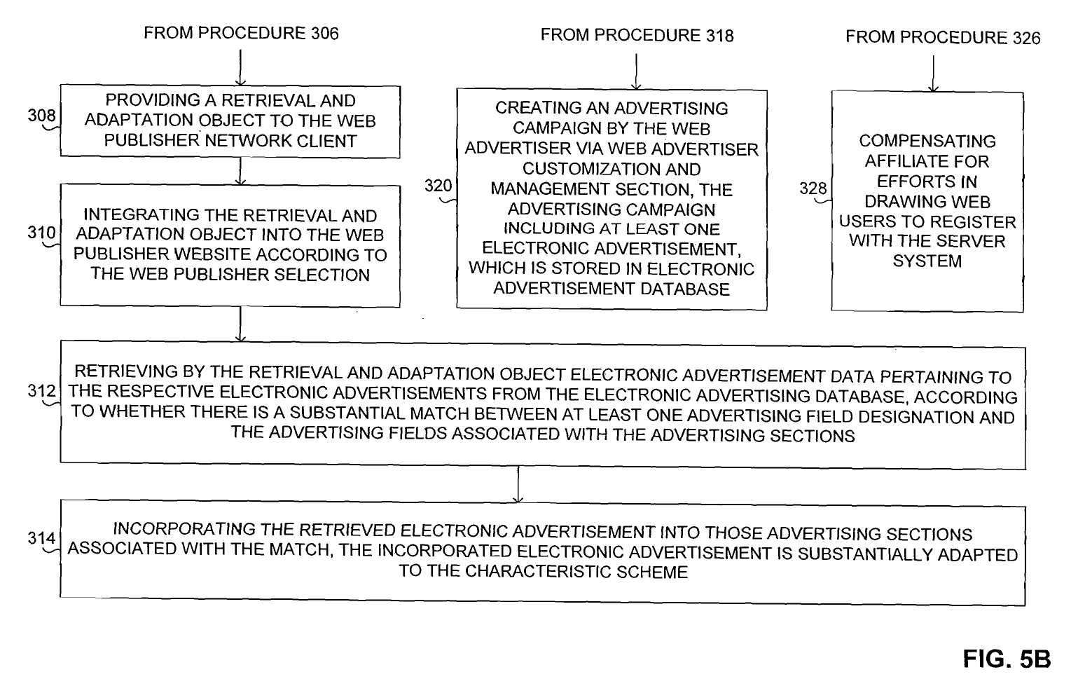

Reference is now made to FIGS. 5A and 5B. FIG. 5A is a schematic illustration of a method, generally referenced 300, for providing an electronic advertisement to a client system via a server system. FIG. 5B is a continuation of the schematic illustration of the method from FIG. 5A. In procedure 302, the client system and the server system establish communications. The server system hosts a server system hosted website. The server system is coupled with an electronic advertisement database that stores a plurality of electronic advertisement data structures that each defines a respective electronic advertisement. Each electronic advertisement data structure attributes at least one advertising field designation to each respective electronic advertisement. With reference to FIGS. 2 and 4, web advertiser network client-server 116 (FIG. 2) and network server 104 of electronic advertising platform 102 establish communications. Network server 104 hosts network server hosted website 106. Network server 104 is coupled with server database 108 that stores electronic advertisements data structures (not shown—see, for example, Table 2) that each defines a respective electronic advertisement (e.g., electronic coupon 146). Each of the electronic advertisements in the catalog (FIG. 4) is attributed at least one advertising field designation.

The following procedures (304, 306, 308, 310, 312 and 314) are directed to the case where the client is a web publisher. In procedure 304, the server system directs the web publisher to access a web publisher customization and management section within the server system hosted website. The web publisher employs a web publisher network client. With reference to FIG. 2, network server 104 directs the web publisher, employing web publisher network client-server 116, to access web publisher customization and management section 132 within network server hosted website 106.

In procedure 306 the web publisher registers with the server system hosted website. The web publisher hosts a web publisher website includes at least one advertising section, and employs a characteristic scheme. The web publisher selects which advertising fields are to be associated with which advertising section of the web publisher website. With reference to FIGS. 2 and 3, the web publisher hosts web publisher website 118 that employs characteristic scheme 120₀ and includes advertising sections 124₀, 130₁, 130₂, 130₃, and 130_{N}. The web publisher selects via advertising category selection GUI 142 (FIG. 3) the advertising field selections 144₀, 144₁, 144₂, 144₃, and 144_{N} to be associated with advertising sections 124₀, 130₁, 130₂, 130₃, and 130_{N}, respectively.

In procedure 308 (FIG. 5B), a retrieval and adaptation object is transferred to the web publisher network client. With reference to FIG. 2, electronic advertising platform 102 provides a retrieval and adaptation object (not shown) to web publisher network client-server 116 via the Internet 114.

In procedure 310, the retrieval and adaptation object is integrated into the web publisher website according to the web publisher selection. With reference to FIG. 3, the retrieval and adaptation object is integrated into web publisher website 118, particularly, into advertising section 124₀ of web publisher homepage 120₀, advertising section 130₁ of web page section 128₁, advertising section 130₂ of web page section 128₂, advertising section 130₃ of web page section 128₃, and advertising section 130_{N} of web page section 128_{N}.

In procedure 312, electronic advertisement data pertaining to the respective electronic advertisement is retrieved by the retrieval and adaptation object from the electronic advertising database, according to whether there is a substantial match between at least one adverting field designation and the advertising fields associated with the advertising sections. With reference to FIG. 4, the retrieval and adaptation object, integrated into advertising section 222₁ of web page sub-section 218₁ (relating to the field of books), retrieves from the catalog, under the classification of “books & magazines” electronic advertising data pertaining to electronic coupon 236. The advertising field associated with web page sub-section 218₁ is books, such is also at least one advertising field designation of electronic coupon 236 (i.e., that of books).

In procedure 314, the retrieved electronic advertisement is incorporated into those advertising sections associated with the match. The incorporated electronic advertisement is substantially adapted to the characteristic scheme. With reference to FIG. 4, electronic coupon 236 is incorporated into advertising section 222₁. The scheme employed by electronic coupon 236 substantially matches characteristic scheme 216 employed by web publisher website 204.

The following procedures (316, 318 and 320) now direct to the case where the client is a web advertiser. In procedure 316 (FIG. 5A), the server system directs the web advertiser to access a web advertiser customization and management section within the server system hosted website. The web advertiser employs a web advertiser network client. With reference to FIG. 2, network server 104 directs the web advertiser, employing web advertiser network client-server 154, to access web advertiser customization and management section 134 within network server hosted website 106.

In procedure 318, the web advertiser registers with the server system. With reference to FIG. 2, the web advertiser, employing web advertiser network client 154 registers with network server 104.

In procedure 320 (FIG. 5B), the web advertiser creates an advertising campaign via the web advertiser customization and management section. The advertising campaign includes at least one electronic advertisement, which is stored in electronic advertisement database. With reference to FIG. 2, the web advertiser creates an advertising campaign (not shown) via web advertiser customization and management section 134. The advertising campaign includes at least one electronic advertisement (e.g., electronic coupon 160, stored in web advertiser database 156), which is stored (not shown) in server database 108.

The following procedures (322, 324, 326 and 328) now direct to the case where the client is an affiliate. In procedure 322 (FIG. 5A), the server system directs the affiliate to access an affiliate customization and management section within the server system hosted website. The affiliate employs an affiliate network client. With reference to FIG. 2, network server 104 directs the affiliate, employing affiliate network client 174, to access affiliate customization and management section 136 within network server hosted website 106.

In procedure 324 the affiliate registers with the server system. With reference to FIG. 2, the affiliate, employing affiliate network client 174 registers with network server 104.

In procedure 326 the affiliate refers web users to register with the server system hosted website. With reference to FIG. 2, as an example, the affiliate refers the web advertiser employing web advertiser network client 154 to register with network server hosted website 106.

In procedure 328 (FIG. 5B), the affiliate is compensated for efforts in drawing web users to register with the server system. With reference to FIG. 2, the web advertiser places electronic coupon 182 into advertising section 130₃ of web publisher website 118 resulting substantially from the efforts made by the affiliate 184. The affiliate is compensated (not shown) by the web advertiser.

It will be appreciated by persons skilled in the art that the disclosed technique is not limited to what has been particularly shown and described hereinabove. Rather the scope of the disclosed technique is defined only by the claims, which follow.

1. Method for providing an electronic advertisement to a client system via a server system, the server system coupled with an electronic advertisement database for storing a plurality of electronic advertisement data structures that each defines a respective electronic advertisement, each electronic advertisement data structure attributes at least one advertising field designation to each respective electronic advertisement, the client system hosting a client website employing a characteristic design scheme, the method comprising the procedures of:
establishing communications between said server system and said client system;
registering said client system with said server system;
providing a retrieval and adaptation object from said server system to said client system,
integrating said retrieval and adaptation object into said client website;
retrieving by said retrieval and adaptation object, said electronic advertisement data pertaining to said respective electronic advertisement, from said electronic advertisement database, according to said at least one advertising field designation; and
incorporating said electronic advertisement into said client webpage, by substantially adapting said retrieved electronic advertising data of the respective said electronic advertisement, to substantially correspond with said characteristic design scheme.

2. The method according to claim 1, further comprising a procedure of directing said client system to access either one of a web publisher customization and management section, a web advertiser customization and management section, and an affiliate customization and management section, within a server system hosted website of said server system.

3. The method according to claim 2, wherein said procedure of registering is with said server system hosted website.

4. The method according to claim 2, wherein said client website includes at least one advertising section.

5. The method according to claim 4, wherein said client system selects which of a plurality of advertising fields are to be associated with which of said at least one advertising section of said client website.

6. The method according to claim 5, wherein said procedure of integrating is with said client website, according to said client system selection.

7. The method according to claim 6, wherein said procedure of retrieving is according to whether there is a substantial match between said at least one advertising field designation and said plurality of advertising fields associated with said at least one advertising section.

8. The method according to claim 7, wherein said procedure of incorporating pertains to those of said at least one advertising section associated with said match.

9. The method according to claim 2, further comprising a procedure of creating an advertising campaign via said network server hosted website, said advertising campaign including at least one said electronic advertisement, which is stored in said electronic advertisement database.

10. The method according to claim 2, further comprising a procedure of referring web users to register with said server system hosted website.

11. The method according to claim 10, further comprising a procedure of compensating a web affiliate said registered with said server system hosted website, for directing said web users to register with said server system hosted website.

12. The method according to claim 1, wherein said electronic advertisement is selected from a list consisting of:
electronic coupon advertisement;
electronic banner advertisement; and
electronic text advertisement.

13. The method according to claim 9, further comprising a procedure of modifying said advertising campaign.

14. The method according to claim 9, further comprising a procedure of deleting said advertising campaign.

15. The method according to claim 1, further comprising a procedure of modifying at least one of said plurality of electronic advertisement data structures, of respective said electronic advertisement.

16. The method according to claim 1, further comprising a procedure of sharing, via said server system, said electronic advertisements stored in said electronic advertisement database, between a plurality of said client systems, each of said client systems is said registered with said server system hosted website.

17. System for providing an electronic advertisement to a client system, the client system hosting a client website employing a characteristic design scheme, the system comprising:
an electronic advertisement database for storing a plurality of electronic advertisement data structures that each defines a respective said electronic advertisement, each said electronic advertisement data structure attributes at least one advertising field designation to each respective said electronic advertisement;
a server system coupled with said electronic advertisement database, said server system and said client system establishing communications therebetween, said server system registering said client system, and
a retrieval and adaptation object, said server system provides said retrieval and adaptation object to said client system, said client system integrating said retrieval and adaptation object into said client website, said retrieval and adaptation object retrieving said electronic advertisement data pertaining to said respective electronic advertisement, from said electronic advertisement database, according to said at least one advertising field designation, said retrieval and adaptation object incorporating said electronic advertisement into said client webpage, by adapting said retrieved electronic advertising data of the respective said electronic advertisement, to substantially correspond with said characteristic design scheme.

18. The system according to claim 17, further comprising a reporting server coupled with said server system.

19. The system according to claim 17, wherein said server system hosts a network server hosted website.

20. The system according to claim 19, wherein said server system operates an electronic advertising platform management system.

21. The system according to claim 19, wherein said network server hosted website includes at least one of a web publisher customization and management section, a web advertiser customization and management section, and an affiliated customization and management section.

22. The system according to claim 20, wherein said electronic advertising platform management system incorporates a user interface for enabling addition, modification, and deletion of data pertaining to said electronic advertisement.

23. The system according to claim 22, wherein said registering involves setting up either one of a web publisher account, a web advertiser account, and a web affiliate account.

24. The system according to claim 23, wherein said client system selects, via said server system, an electronic advertisement program from a selection of electronic advertisement programs, each said electronic advertisement program is defined by its respective advertisement program data.

25. The system according to claim 24, wherein each said electronic advertisement program is associated with a particular kind of electronic advertisement.

26. The system according to claim 24, wherein said client system modifies said electronic advertisement program data of respective said electronic advertisement program.

27. The system according to claim 24, wherein said client system deletes said electronic advertisement program.

28. The system according to claim 24, wherein said selection of electronic advertisement programs is selected from a list consisting of:
electronic coupon advertisement program;
electronic banner advertisement program; and
electronic text advertisement program.

29. The system according to claim 22, wherein said server system provides said client system via said web publisher customization and management section with an advertisement category selection that is classified substantially according to content.

30. The system according to claim 17, wherein said client website further includes at least one advertising section.

31. The system according to claim 29, wherein said client system selects which of a plurality of advertising fields are to be associated with which of said at least one advertising section of said client website.

32. The system according to claim 29, wherein said integrating is with said client website, according to said client system selection.

33. The system according to claim 29, wherein said retrieving is according to whether there is a substantial match between said at least one advertising field designation and said plurality of advertising fields associated with said at least one advertising section.

34. The system according to claim 30, wherein said incorporating pertains to those of said at least one advertising sections associated with said match.

35. The system according to claim 17, wherein said retrieval and adaptation object is selected from a list consisting of:
Extensible Markup Language (XML) file; and
Inline Frame (IFrame) HyperText Markup Language (HTML) element.

36. The system according to claim 26, wherein said network server hosted website enables creation, modification, and deletion of an advertising campaign, said advertising campaign including at least one said electronic advertisement, which is stored in said electronic advertisement database.

37. The system according to claim 17, wherein said server system modifies at least one of said plurality of electronic advertisement data structures, respective of said electronic advertisement.

38. The system according to claim 17, wherein said electronic advertisement stored in said electronic advertisement database is shared, via said server system, between a plurality of said client systems, each of said client systems said registered with is said server system hosted website.
